(19) United States
(12) Patent Application Publication
(10) Pub. No.: US 2026/0154107 A1
(43) Pub. Date: Jun. 4, 2026

(54) METHOD AND DEVICE FOR DISTRIBUTED OPERATION

(71) Applicant: Electronics and Telecommunications Research Institute, Daejeon (KR)

(72) Inventor: Hyun Mi Kim, Daejeon (KR)

(73) Assignee: Electronics and Telecommunications Research Institute, Daejeon (KR)

(21) Appl. No.: 19/404,171

(22) Filed: Dec. 1, 2025

(30) Foreign Application Priority Data
Dec. 2, 2024 (KR) 10-2024-0176750
Nov. 19, 2025 (KR) 10-2025-0175506

(51) Int. Cl. G06F 9/48

(52) U.S. Cl. CPC G06F 9/4881

(57) ABSTRACT

Disclosed are a method and a device for distributed operation. The computing device includes a plurality of processing devices; and an interconnector connected to the plurality of processing devices and configured to provide data transmission paths for the plurality of processing devices, wherein the interconnector is configured to selectively activate a first data transmission path from a source device to one target processing device and a second data transmission path from the source device to a plurality of target processing devices, and the source device includes one of the plurality of processing devices or a storage device shared by the plurality of processing devices.

### CROSS-REFERENCE TO RELATED APPLICATION

This application claims the benefit of and priority to Korean Patent Application No. 10-2024-0176750, filed on Dec. 2, 2024 and Korean Patent Application No. 10-2025-0175506, filed on Nov. 19, 2025, the entire disclosure(s) of which is hereby incorporated herein by reference in its entirety.

### BACKGROUND

The present disclosure relates to a method and a device for distributed operation.

The statements in this section merely provide background information related to the present disclosure and do not necessarily constitute prior art.

To train a large-scale artificial neural network for high-performance artificial intelligence, a learning environment capable of processing a vast number of parameters and large datasets is required. For this purpose, distributed learning methods are essential, wherein parameters and data are distributed and processed across multiple servers comprising multiple processing devices (e.g., graphics processing units (GPUs), tensor processing units (TPUs), or neural processing units (NPUs)). During distributed learning, all the memory and computing resources supported by multiple servers or devices may be utilized, enabling the training of models with an increasingly large number of parameters and datasets. However, during collective operations in which intermediate data or training results are required to be synchronized across all participating devices, large-scale data transfer between devices or servers may act as a bottleneck, thereby reducing the training speed.

Also, as the size of large-scale artificial neural networks continues to grow, the matrices used in matrix multiplication—the core operation of neural networks—also increase in size, which necessitates distributed matrix multiplication operations in which the matrices are partitioned and computed in parallel across multiple devices. At this time, each submatrix may need to be loaded multiple times onto different devices, and in general computing systems, performance degradation may occur due to the limited memory bandwidth or interconnect bandwidth required for the repeated loading operations.

### SUMMARY

According to one aspect of the present disclosure, a computing device is provided. The computing device includes a plurality of processing devices; and an interconnector connected to the plurality of processing devices and configured to provide data transmission paths for the plurality of processing devices. The interconnector is configured to selectively activate a first data transmission path from a source device—wherein the source device includes one of the plurality of processing devices or a storage device shared by the plurality of processing devices—to one target processing device and a second data transmission path from the source device to a plurality of target processing devices.

According to another aspect of the present disclosure, a method performed by a computing device including a plurality of processing devices is provided. The method includes selectively activating a first data transmission path from a source device—wherein the source device includes one of the plurality of processing devices or a storage device shared by the plurality of processing devices—to one target processing device and a second data transmission path from the source device to a plurality of target processing devices; and transmitting data through the activated data transmission path.

According to still another aspect of the present disclosure, an interconnector connected to a plurality of processing devices and configured to provide data transmission paths for the plurality of processing devices is provided. The interconnector is configured to selectively activate a first data transmission path from a source device—wherein the source device includes one of the plurality of processing devices or a storage device shared by the plurality of processing devices—to one target processing device and a second data transmission path from the source device to a plurality of target processing devices.

### BRIEF DESCRIPTION OF DRAWINGS

FIG. 1 is a block diagram illustrating a computing device according to an embodiment of the present disclosure.

FIG. 2 is a block diagram illustrating a processing device according to an embodiment of the present disclosure.

FIG. 3 is a diagram illustrating an address structure for multicast transmission according to an embodiment of the present disclosure.

FIG. 4 is a diagram illustrating a collective operation according to an embodiment of the present disclosure.

FIG. 5 is a diagram illustrating a reduce-scatter operation process according to an embodiment of the present disclosure.

FIG. 6 is a diagram illustrating data transmission paths activated in a reduce-scatter operation process according to an embodiment of the present disclosure.

FIG. 7 is a diagram illustrating an all-gather operation process according to an embodiment of the present disclosure.

FIG. 8 is a diagram illustrating data transmission paths activated in an all-gather operation process according to an embodiment of the present disclosure.

FIG. 9 is an exemplary diagram referenced to describe a distributed matrix multiplication operation according to an embodiment of the present disclosure.

FIG. 10 is a diagram illustrating a distributed matrix multiplication operation process according to an embodiment of the present disclosure.

FIG. 11 is a diagram illustrating data transmission paths activated in a distributed matrix multiplication operation process according to an embodiment of the present disclosure.

FIG. 12 is an exemplary diagram referenced to describe a distributed matrix multiplication operation according to another embodiment of the present disclosure.

FIG. 13 is a diagram illustrating a distributed matrix multiplication operation process according to another embodiment of the present disclosure.

FIG. 14 is a diagram illustrating data transmission paths activated in a distributed matrix multiplication operation process according to another embodiment of the present disclosure.

FIG. 15 is a flowchart illustrating a data transmission method for distributed operations according to an embodiment of the present disclosure.

### DETAILED DESCRIPTION

The present disclosure may provide a device and a method capable of overcoming the limitations caused by data transfer during collective operations and/or distributed matrix multiplication operations, and of performing computations more efficiently by using a multicast-based interconnector.

The features of the present disclosure are not limited to the aforementioned features, and other features not described above may be evidently understood by a person having ordinary skill in the art to which the present disclosure pertains from the following description.

Hereinafter, some exemplary embodiments of the present disclosure will be described in detail with reference to the accompanying drawings. In the following description, like reference numerals preferably designate like elements, although the elements are shown in different drawings. Further, in the following description of some embodiments, a detailed description of known functions and configurations incorporated therein will be omitted for the purpose of clarity and for brevity.

Additionally, various terms such as first, second, A, B, (a), (b), etc., are used solely to differentiate one component from the other but not to imply or suggest the substances, order, or sequence of the components. Throughout this specification, when a part ‘includes’ or ‘comprises’ a component, the part is meant to further include other components, not to exclude thereof unless specifically stated to the contrary. The terms such as ‘unit’, ‘module’, and the like refer to one or more units for processing at least one function or operation, which may be implemented by hardware, software, or a combination thereof.

The following detailed description, together with the accompanying drawings, is intended to describe exemplary embodiments of the present disclosure and is not intended to represent the only embodiments in which the present disclosure may be practiced.

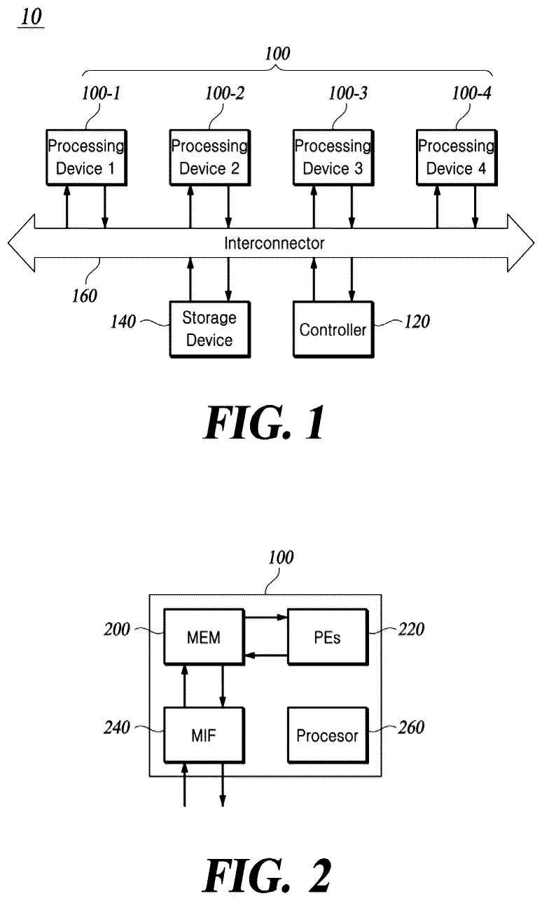

FIG. 1 is a block diagram illustrating a computing device according to an embodiment of the present disclosure.

The computing device 10 according to an embodiment of the present disclosure may include a plurality of processing devices 100-1, 100-2, 100-3, and 100-4, a controller 120, a storage device 140, and an interconnector 160. It should be understood that not all blocks illustrated in FIG. 1 are essential components, and that some blocks included in other embodiments may be added, modified, or removed.

The computing device 10 may perform operations for training or inference of an artificial neural network, preferably a large-scale artificial neural network.

The plurality of processing devices 100-1, 100-2, 100-3, and 100-4 may be physically separate devices, different processors within a single chip, or different cores within a single chip. For example, when the computing device 10 is implemented as a System on Chip (SoC) or a chiplet, each processing device 100-1, 100-2, 100-3, or 100-4 may be any specialized processor capable of efficiently processing computations for an artificial intelligence model, such as a Graphics Processing Unit (GPU), a Tensor Processing Unit (TPU), or a Neural Processing Unit (NPU). In another example, when the computing device 10 is implemented as a server, each processing device 100-1, 100-2, 100-3, or 100-4 may be a board or a rack including a plurality of processors. In other words, the computing device 10 may represent a concept encompassing various levels of systems capable of effectively performing neural network training or inference. In what follows, descriptions will be given based on an assumption that the computing device 10 is implemented as an SoC or a chiplet. Meanwhile, although FIG. 1 illustrates the computing device 10 as including four processing devices 100-1, 100-2, 100-3, and 100-4, the present disclosure is not limited to the specific example. In other words, the computing device 10 may include fewer or more processing devices than the four processing devices 100-1, 100-2, 100-3, and 100-4 assumed in the description.

FIG. 2 is a block diagram illustrating a processing device according to an embodiment of the present disclosure.

Referring to FIG. 2, a processing device 100 according to an embodiment of the present disclosure may include all or some of a memory (MEM) 200, processing elements (PEs) 220, a memory interface (MIF) 240, and a processor 260.

The memory 200 may support high-speed data storage. For example, the memory 200 may store and provide operand data such as weights or activation values required for computation at high speed. To improve speed, the memory 200 may have a structure in which reading and writing are performed simultaneously (e.g., a double-buffering structure). In the present disclosure, the memory 200 may also be referred to as an internal memory. The processing elements 220 may receive data from the memory 200 and may perform operations of an artificial neural network, such as multiplication-accumulation (MAC), in parallel. The memory interface 240 may manage data transfer. For example, the memory interface 240 may efficiently control data flow to and from another processing device 100 or the storage device 140. The processor 260 may control operations of the processing device 100. For example, the processor 260 may interpret instructions and may control the operating sequence of the processing elements 220 and the memory interface 240 to manage the overall computation process.

Referring again to FIG. 1, the controller 120 may control the entire system of the computing device 10 or may support synchronization among the processing devices 100-1, 100-2, 100-3, and 100-4. The controller 120 may be referred to as a main processor or a control processor.

The storage device 140 may be shared among the plurality of processing devices 100-1, 100-2, 100-3, and 100-4. The storage device 140 may be referred to as, for example, a large-capacity storage device or a global memory.

Connections among components of the computing device 10 may be made through the interconnector 160. The interconnector 160 may be equipped with a multicast function that enables simultaneous data transmission to the plurality of processing devices 100-1, 100-2, 100-3, and 100-4. For example, the interconnector 160 may include a switch supporting multicast or a Direct Memory Access (DMA).

FIG. 3 is a diagram illustrating an address structure for multicast transmission according to an embodiment of the present disclosure.

Referring to FIG. 3, the address 30 for multicast transmission may include a device identification field 300 for identifying a target processing device corresponding to the destination and a data address field 320 for indicating the address at which data is to be stored within each processing device.

The device identification field 300 may include information designating one or more processing devices 100-1 to 100-4 supposed to receive data. For example, the device identification field 300 may include a plurality of flag bits that may be independently set to 0 or 1. Each flag bit within the field may be mapped in a one-to-one manner to a specific processing device 100-1, 100-2, 100-3, or 100-4. For example, when the device identification field 300 is configured with four bits, a first flag bit may correspond to processing device 100-4, a second flag bit may correspond to processing device 100-3, a third flag bit may correspond to processing device 100-2, and a fourth flag bit may correspond to processing device 100-1.

When the interconnector 160 receives the address 30 or a packet including the address 30, the interconnector 160 may check the device identification field 300. When a flag bit corresponding to a specific processing device 100-1, 100-2, 100-3, or 100-4 has a value of 1, a router of the interconnector 160 may transmit data together with an internal memory address to the corresponding processing device 100-1, 100-2, 100-3, or 100-4. Accordingly, the processing device 100-1, 100-2, 100-3, or 100-4 may store the received data at a designated address within its internal memory.

To perform multicast transmission, a plurality of flag bits within the field are allowed to be defined as 1 simultaneously. For example, when the value of the device identification field 300 is “1110,” the interconnector 160 may transmit data simultaneously to processing devices 100-2, 100-3, and 100-4.

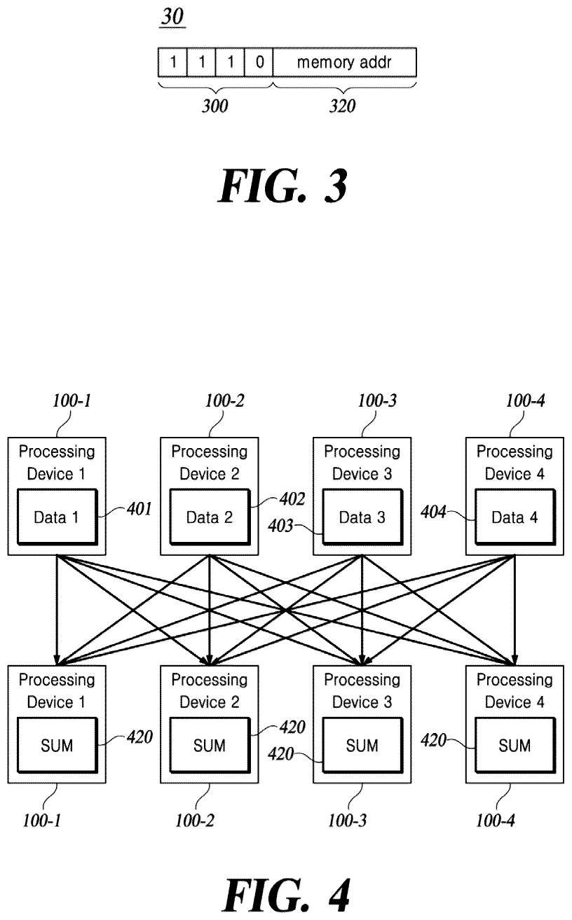

FIG. 4 is a diagram illustrating a collective operation according to an embodiment of the present disclosure.

The processing devices 100-1, 100-2, 100-3, and 100-4 may perform collective operations by utilizing the interconnector 160 that supports multicast. The collective operations may include, for example, scatter, gather, broadcast, all-reduce, and/or all-gather.

FIG. 4 illustrates an all-reduce operation as an example of collective operation. The all-reduce operation is an operation intended for all of the processing devices 100-1, 100-2, 100-3, and 100-4 to commonly share a result 420 obtained by performing a specific reduction operation on the respective data 401, 402, 403, and 404 held by the processing devices 100-1, 100-2, 100-3, and 100-4. The reduce operation may include, for example, addition, multiplication, maximum selection, minimum selection, logical OR, or logical AND. In what follows, the reduction of data is assumed to be performed by addition operation.

The all-reduce operation is essential in a distributed deep-learning environment. In a data-parallelism learning scheme, the all-reduce operation may be used to obtain a total sum of gradients computed in a distributed manner by each processing device and to allow all processing devices to share the total sum so that each processing device updates its weights in the same manner, thereby achieving model synchronization. Also, the all-reduce operation may be frequently utilized throughout distributed learning, for example, to aggregate partial results obtained by partitioning weights and processing the weights in parallel or to compute statistics (e.g., mean and variance) for the entire batch when performing distributed layer normalization.

The most straightforward method for implementing the all-reduce operation is for one processing device (e.g., processing device 100-1) to collect all data distributed across other processing devices (e.g., processing devices 100-2, 100-3, and 100-4), perform summation with its own local data, and then transmit the summation result 420 to the other processing devices. However, the above method requires transferring a very large amount of data among the processing devices, which may cause significant decrease in computational speed due to communication overhead.

To address the problem above, a method may be used, which performs a reduce-scatter operation for a plurality of processing devices 100-1, 100-2, 100-3, and 100-4 to perform the reduce operation in a distributed manner and an all-gather operation to collect partial operation results distributed across the processing devices 100-1, 100-2, 100-3, and 100-4 into each processing device 100-1, 100-2, 100-3, or 100-4.

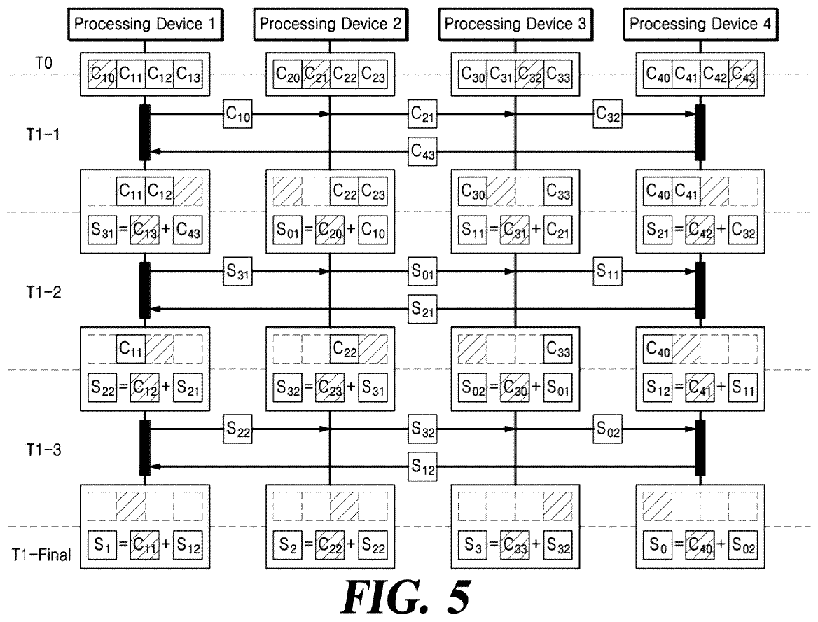

FIG. 5 is a diagram illustrating a reduce-scatter operation process according to an embodiment of the present disclosure.

At an initial time step T0, the processing devices 100-1, 100-2, 100-3, and 100-4 may divide the data stored in each device into a plurality of chunk data that are independent of the all-reduce operation. Each processing device 100-1, 100-2, 100-3, or 100-4 may generate the same number of chunk data as the number of processing devices 100-1, 100-2, 100-3, and 100-4 participating in the operation. For example, when the number of processing devices 100-1, 100-2, 100-3, and 100-4 participating in the operation is four, each processing device 100-1, 100-2, 100-3, or 100-4 may divide its own data into four chunk data. In the example of FIG. 5, processing device 100-1 may generate four chunk data C₁₀, C₁₁, C₁₂, and C₁₃; processing device 100-2 may generate four chunk data C₂₀, C₂₁, C₂₂, and C₂₃; processing device 100-3 may generate four chunk data C₃₀, C₃₁, C₃₂, and C₃₃; and processing device 100-4 may generate four chunk data C₄₀, C₄₁, C₄₂, and C₄₃.

For the reduce-scatter operation, a connection structure may be predefined among the processing devices 100-1, 100-2, 100-3, and 100-4. For example, the processing devices 100-1, 100-2, 100-3, and 100-4 may be configured to form a logical ring topology. In the ring structure, a one-to-one unidirectional connectivity relationship may be predefined, wherein processing device 100-1 transmits data to processing device 100-2, processing device 100-2 may transmit data to processing device 100-3, processing device 100-3 may transmit data to processing device 100-4, and processing device 100-4 may transmit data to processing device 100-1.

The reduce-scatter operation may be performed in such a manner that chunk data are transmitted to the next neighboring processing device along the ring topology, and a partial reduce operation is performed between data received from a previous neighboring processing device and the local chunk data. The partial reduce operation may include, for example, addition, multiplication, maximum selection, minimum selection, logical OR, or logical AND. Each processing device 100-1, 100-2, 100-3, or 100-4 may perform the partial reduce operation using the processing elements 220 included therein. The partial reduce operation may also be referred to as a partial collective operation. In the following description, the partial reduce operation is assumed to correspond to adding the received data to the local chunk data.

For example, in the first time step T1-1, each processing device 100-1, 100-2, 100-3, or 100-4 may transmit chunk data at a specific position among its own chunk data to a predetermined next neighboring processing device along the ring topology and may receive chunk data at a different position from a previous neighboring processing device. Each processing device 100-1, 100-2, 100-3, and 100-4 may transmit chunk data at a different position. For example, processing device 100-1 may transmit the 0-th chunk data C₁₀ to processing device 100-2; processing device 100-2 may transmit the 1st chunk data C₂₁ to processing device 100-3; processing device 100-3 may transmit the 2nd chunk data C₃₂ to processing device 100-4; and processing device 100-4 may transmit the 3rd chunk data C₄₃ to processing device 100-1.

Each processing device 100-1, 100-2, 100-3, or 100-4 may add the chunk data received from a previous neighboring processing device to its local chunk data at the corresponding position. For example, processing device 100-1 may add the 3rd chunk data C₄₃ received from processing device 100-4 to its own 3rd chunk data C₁₃ to generate an initial partial sum data S₃₁ for the 3rd chunk position. Processing device 100-2 may add the 0-th chunk data C₁₀ received from processing device 100-1 to its own 0-th chunk data C₂₀ to generate an initial partial sum data S₀₁ for the 0-th chunk position. Processing device 100-3 may add the 1st chunk data C₂₁ received from processing device 100-2 to its own 1st chunk data C₃₁ to generate an initial partial sum data S₁₁ for the 1st chunk position. Processing device 100-4 may add the 2nd chunk data C₃₂ received from processing device 100-3 to its own 2nd chunk data C₄₂ to generate an initial partial sum data S₂₁ for the 2nd chunk position.

In the second time step T1-2, each processing device 100-1, 100-2, 100-3, or 100-4 may transmit the partial sum data generated in the first time step T1-1 to the next neighboring processing device along the ring topology and may receive partial sum data for another chunk position from a previous neighboring processing device.

Each processing device 100-1, 100-2, 100-3, or 100-4 may add the received partial sum data to its local chunk data at the corresponding chunk position to generate updated partial sum data. For example, processing device 100-1 may add the partial sum data S₂₁ received from processing device 100-4 to its own 2nd chunk data C₁₂ to generate updated partial sum data S₂₂ for the 2nd chunk position. Processing device 100-2 may add the partial sum data S₃₁ received from processing device 100-1 to its own 3rd chunk data C₂₃ to generate updated partial sum data S₃₂ for the 3rd chunk position. Processing device 100-3 may add the partial sum data S₀₁ received from processing device 100-2 to its own 0-th chunk data C₃₀ to generate updated partial sum data S₀₂ for the 0-th chunk position. Processing device 100-4 may add the partial sum data S₁₁ received from processing device 100-3 to its own 1st chunk data C₄₁ to generate updated partial sum data S₁₂ for the 1st chunk position.

In the third time step T1-3, each processing device 100-1, 100-2, 100-3, or 100-4 may transmit the partial sum data generated in the second time step T1-2 again to the next processing device along the ring topology and receive partial sum data for another chunk position from a previous neighboring processing device.

Each processing device 100-1, 100-2, 100-3, or 100-4 may add the partial sum data received from the previous processing device to its remaining local chunk data to generate a final reduce operation result. For example, processing device 100-1 may add the partial sum data S₁₂ received from processing device 100-4 to its own 1st chunk data C₁₁ to generate the final sum S₁ for all 1st chunk data. Processing device 100-2 may add the partial sum data S₂₂ received from processing device 100-1 to its own 2nd chunk data C₂₂ to generate the final sum S₂ for all 2nd chunk data. Processing device 100-3 may add the partial sum data S₃₂ received from processing device 100-2 to its own 3rd chunk data C₃₃ to generate the final sum S₃ for all 3rd chunk data. Processing device 100-4 may add the partial sum data S₀₂ received from processing device 100-3 to its own 0-th chunk data C₄₀ to generate the final sum S₀ for all 0-th chunk data.

When the number of processing devices 100-1, 100-2, 100-3, and 100-4 participating in the operation is N, each processing device 100-1, 100-2, 100-3, or 100-4 may, through (N−1) times of data transmission and partial sum computation, hold the final sum for the chunk data at a specific position in a distributed manner. For example, the memory 200 of processing device 100-1 may store the final sum S₁ for the 1st chunk position, the memory 200 of processing device 100-2 may store the final sum S₂ for the 2nd chunk position, the memory 200 of processing device 100-3 may store the final sum S₃ for the 3rd chunk position, and the memory 200 of processing device 100-4 may store the final sum S₀ for the 0-th chunk position.

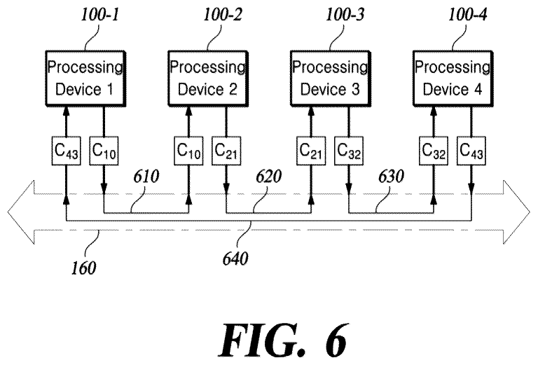

FIG. 6 is a diagram illustrating data transmission paths activated in a reduce-scatter operation process according to an embodiment of the present disclosure.

The data transmitted by each processing device 100-1, 100-2, 100-3, or 100-4 may be transferred to the next neighboring processing device through the interconnector 160. During the reduce-scatter operation, among the data transmission paths provided in the interconnector 160, the one-to-one data transmission paths between neighboring processing devices may be simultaneously activated.

FIG. 6 illustrates paths through which data is transferred during the first time step T1-1 shown in FIG. 5. Referring to FIG. 6, the path 610 for transferring data from processing device 100-1 to processing device 100-2, the path 620 for transferring data from processing device 100-2 to processing device 100-3, the path 630 for transferring data from processing device 100-3 to processing device 100-4, and the path 640 for transferring data from processing device 100-4 to processing device 100-1 may be simultaneously activated. The data transmission paths may be implemented by unicast paths of the interconnector 160 or may be implemented by selectively activating only the paths leading to a single target among the multicast paths. For example, when one-to-one communication is performed based on the address structure shown in FIG. 3, the interconnector 160 may receive an address or a packet in which only one flag bit of the device identification field 300 is set to “1.” For example, for data transfer between processing device 100-1 and processing device 100-2, the interconnector 160 may receive an address or a packet whose device identification field 300 is set to the value “0010.” Such an address or packet may be transmitted together with data by the source processing device or may be provided by the controller 120.

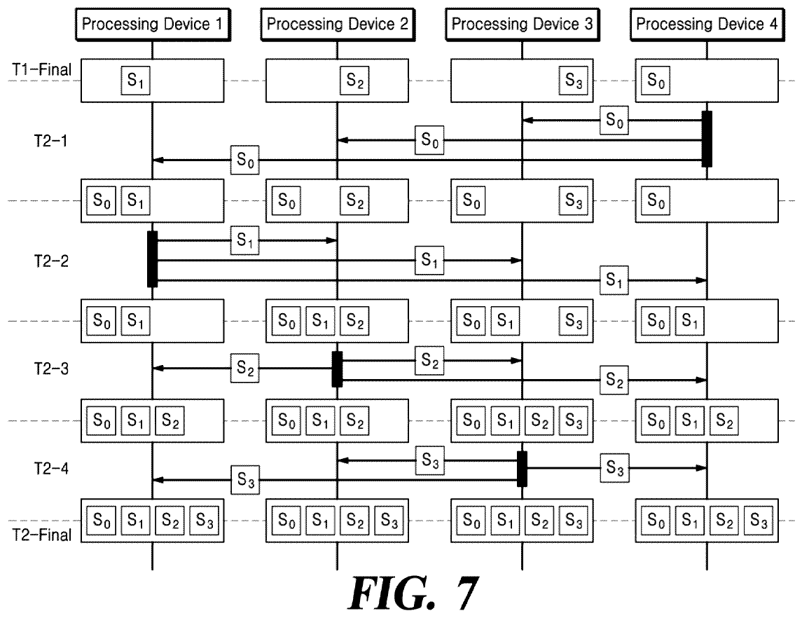

FIG. 7 is a diagram illustrating an all-gather operation process according to an embodiment of the present disclosure.

At the point T1-Final when the reduce-scatter operation is completed, the processing devices 100-1, 100-2, 100-3, and 100-4 may hold the final sums for different chunk positions in a distributed manner. For example, processing device 100-1 may hold the final sum S₁ for 1st position, processing device 100-2 may hold the final sum S₂ for 2nd position, processing device 100-3 may hold the final sum S₃ for 3rd position, and processing device 100-4 may hold the final sum S₀ for 0-th position.

During the all-gather operation process, each processing device 100-1, 100-2, 100-3, or 100-4 may utilize the multicast function of the interconnector to simultaneously transmit the final sum S₀, S₁, S₂, or S₃ that it holds to all other processing devices. The processing devices 100-1, 100-2, 100-3, and 100-4 may sequentially transmit the final sums S₀, S₁, S₂, or S₃ through a plurality of time steps. In other words, in each time step, only one processing device 100-1, 100-2, 100-3, or 100-4 may transmit the data it holds to other devices.

For example, in the first time step T2-1, processing device 100-4 may simultaneously transmit the final sum S₀ for 0-th position to other processing devices 100-1, 100-2, and 100-3. In the second time step T2-2, processing device 100-1 may simultaneously transmit the final sum S₁ for 1st position to other processing devices 100-2, 100-3, and 100-4. In the third time step T2-3, processing device 100-2 may simultaneously transmit the final sum S₂ for position 2 to processing devices 1, 3, and 4 (100-1, 100-3, and 100-4). In the fourth time step T2-4, processing device 100-3 may simultaneously transmit the final sum S₃ for 3rd position to other processing devices 100-1, 100-2, and 100-4.

When the number of processing devices 100-1, 100-2, 100-3, and 100-4 participating in the operation is N, each processing device 100-1, 100-2, 100-3, or 100-4 may store, in its own memory, the final sums S₀, S₁, S₂, and S₃ for all chunk positions through N data transmissions.

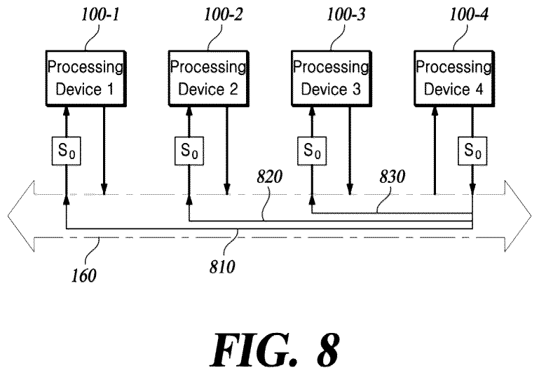

FIG. 8 is a diagram illustrating data transmission paths activated in an all-gather operation process according to an embodiment of the present disclosure.

The data transmitted by each processing device 100-1, 100-2, 100-3, or 100-4 may be transferred to other processing devices via the interconnector 160. In the all-gather operation, a plurality of data transmission paths may be simultaneously activated, in which a single processing device is defined as a source and each of the plurality of processing devices is defined as a target.

FIG. 8 illustrates the paths along which data is transferred during the first time step T2-1 shown in FIG. 7. Referring to FIG. 8, during the first time step T2-1, a path 810 for transmitting data from processing device 100-4 to processing device 100-1, a path 820 for transmitting data from processing device 100-4 to processing device 100-2, and a path 830 for transmitting data from processing device 100-4 to processing device 100-3 may be simultaneously activated. Such data transmission paths may be implemented through the multicast function provided in the interconnector 160. For example, when one-to-many communication is performed based on the address structure shown in FIG. 3, the interconnector 160 may receive an address or a packet in which all flag bits mapped to the processing devices other than the source within the device identification field 300 are set to “1.” For example, during the first time step T2-1, the interconnector 160 may receive an address or a packet in which the device identification field 300 is set to “1110.” Such an address or packet may be transmitted together with data by the source processing device or may be provided by the controller 120.

Since the result data of partial reduce operation (e.g., the sum S₀ for 0-th chunk position) only needs to be read once from the source processing device, bandwidth may be reduced. Also, since the same result data of partial reduce operation may be delivered to a plurality of processing devices at once, the transmission speed may be improved.

Meanwhile, although the description above assumes that processing devices 100-1, 100-2, 100-3, and 100-4 perform an all-reduce operation as a collective operation, the present disclosure is not limited to the specific assumption. In other words, as long as the processing devices 100-1, 100-2, 100-3, and 100-4 efficiently transfer the operation result to a plurality of other processing devices 100-1, 100-2, 100-3, and 100-4 by utilizing the interconnector 160 supporting multicast transmission, the technical principles of the present disclosure may be applied without substantial modification thereof.

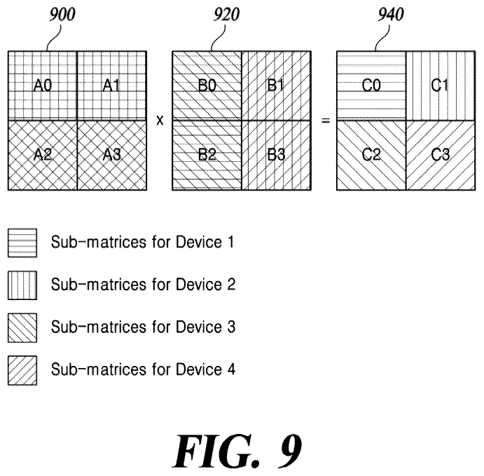

FIG. 9 is an exemplary diagram referenced to describe a distributed matrix multiplication operation according to an embodiment of the present disclosure.

The processing devices 100-1, 100-2, 100-3, and 100-4 may utilize the interconnector 160, which may support multicast, to process a matrix multiplication operation in a distributed manner.

To allow each processing device 100-1, 100-2, 100-3, or 100-4 to process partial matrix multiplication operations, the operand matrices 900 and 920 may be divided into a plurality of submatrices (or blocks). For example, when the number of processing devices 100-1, 100-2, 100-3, and 100-4 participating in the computation is N×M, a first operand matrix 900 may be divided into N×P submatrices, and a second operand matrix 920 may be divided into P×M submatrices. Each processing device 100-1, 100-2, 100-3, or 100-4 may be dedicated to computing one of the N×M submatrices of a resultant matrix 940.

FIG. 9 illustrates an example in which the first operand matrix 900 is divided into 2×2 submatrices A0 to A3, and the second operand matrix 920 is divided into 2×2 submatrices B0 to B3. The resultant matrix 940 may be composed of 2×2 submatrices C0 to C3, and the four processing devices 100-1, 100-2, 100-3, and 100-4 may be dedicated to computing one of the submatrices C0 to C3. For example, processing device 100-1 may be allocated to compute the upper-left submatrix C0, processing device 100-2 may be allocated to compute the upper-right submatrix C1, processing device 100-3 may be allocated to compute the lower-left submatrix C2, and processing device 100-4 may be allocated to compute the lower-right submatrix C3.

Different combinations of operand submatrices A0 to A3 and B0 to B3 may be supplied to each processing device 100-1, 100-2, 100-3, and 100-4. For example, processing device 100-1 may be supplied with the upper submatrices A0 and A1 of the first operand matrix 900 and the left submatrices B0 and B2 of the second operand matrix 920. Processing device 100-2 may be supplied with the upper submatrices A0 and A1 of the first operand matrix 900 and the right submatrices B1 and B3 of the second operand matrix 920. Processing device 100-3 may be supplied with the lower submatrices A2 and A3 of the first operand matrix 900 and the left submatrices B0 and B2 of the second operand matrix 920. Processing device 100-4 may be supplied with the lower submatrices A2 and A3 of the first operand matrix 900 and the right submatrices B1 and B3 of the second operand matrix 920.

During the process of supplying operand submatrices, the multicast function of the interconnector 160 may be utilized to improve efficiency of the memory bandwidth. For example, the interconnector 160 may simultaneously transmit the respective operand submatrices loaded from the storage device 140 to two or more processing devices 100-1, 100-2, 100-3, and/or 100-4.

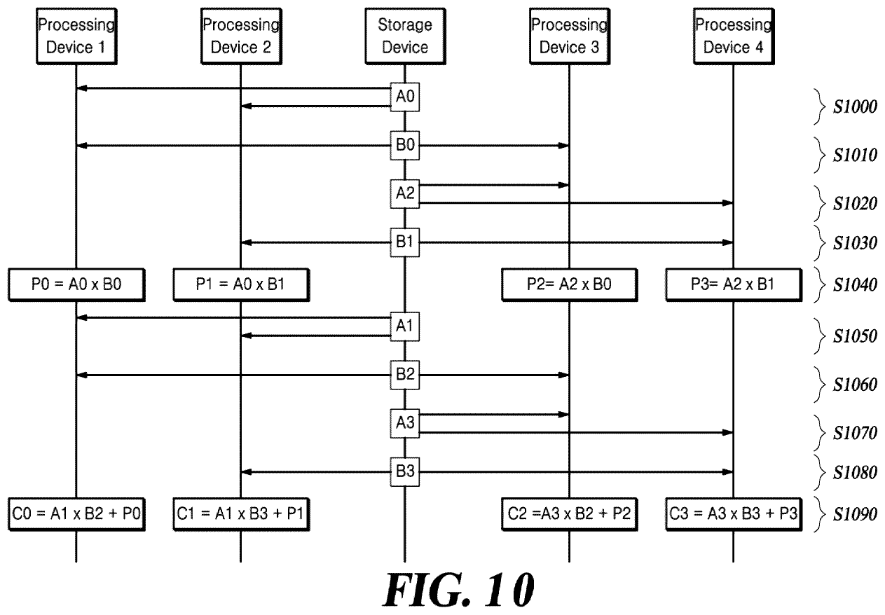

FIG. 10 is a diagram illustrating a distributed matrix multiplication operation process according to an embodiment of the present disclosure.

The distributed matrix multiplication illustrated in FIG. 9 may include two stages for obtaining partial products.

At steps S1000 to S1030, the interconnector 160 may multicast the operand submatrices required for the first-stage computation. In the multicast operations, the operand submatrices may be simultaneously transmitted to different combinations of processing devices.

At step S1000, the interconnector 160 may simultaneously transmit the upper-left submatrix A0 of the first operand matrix loaded from the storage device 140 to the processing device 100-1 and the processing device 100-2. The processing device 100-1 and the processing device 100-2 may store the received submatrix A0 in their respective internal memories 200.

At step S1010, the interconnector 160 may simultaneously transmit the upper-left submatrix B0 of the second operand matrix loaded from the storage device 140 to the processing device 100-1 and the processing device 100-3. The processing device 100-1 and the processing device 100-3 may store the received submatrix B0 in their respective internal memories 200.

At step S1020, the interconnector 160 may simultaneously transmit the lower-left submatrix A2 of the first operand matrix loaded from the storage device 140 to the processing device 100-3 and the processing device 100-4. The processing device 100-3 and the processing device 100-4 may store the received submatrix A2 in their respective internal memories 200.

At step S1030, the interconnector 160 may simultaneously transmit the upper-right submatrix B1 of the second operand matrix loaded from the storage device 140 to the processing device 100-2 and the processing device 100-4. The processing device 100-2 and the processing device 100-4 may store the received submatrix B1 in their respective internal memories 200.

After the transmission of all operand submatrices required for the first-stage computation is finished through the steps S1000 to S1030, each processing device 100-1, 100-2, 100-3, or 100-4 may compute a first partial product using the submatrices stored in its internal memory 200 at step S1040. For example, the processing device 100-1 may multiply the upper-left submatrix A0 of the first operand matrix with the upper-left submatrix B0 of the second operand matrix to generate a partial product P0. The processing device 100-2 may multiply the upper-left submatrix A0 of the first operand matrix with the upper-right submatrix B1 of the second operand matrix to generate a partial product P1. The processing device 100-3 may multiply the lower-left submatrix A2 of the first operand matrix with the upper-left submatrix B0 of the second operand matrix to generate a partial product P2. The processing device 100-4 may multiply the lower-left submatrix A2 of the first operand matrix with the upper-right submatrix B1 of the second operand matrix to generate a partial product P3. Each processing device 100-1, 100-2, 100-3, or 100-4 may store the generated partial product in its internal memory 200.

At steps S1050 to S1080, the interconnector 160 may multicast the operand submatrices required for the second-stage computation.

At step S1050, the interconnector 160 may simultaneously transmit the upper-right submatrix A1 of the first operand matrix, loaded from the storage device 140, to the processing device 100-1 and the processing device 100-2. The processing device 100-1 and the processing device 100-2 may store the received submatrix A1 in their respective internal memories 200.

At step S1070, the interconnector 160 may simultaneously transmit the lower-left submatrix B2 of the second operand matrix, loaded from the storage device 140, to the processing device 100-1 and the processing device 100-3. The processing device 100-1 and the processing device 100-3 may store the received submatrix B2 in their respective internal memories 200.

At step S1060, the interconnector 160 may simultaneously transmit the lower-right submatrix A3 of the first operand matrix, loaded from the storage device 140, to the processing device 100-3 and the processing device 100-4. The processing device 100-3 and the processing device 100-4 may store the received submatrix A3 in their respective internal memories 200.

At step S1080, the interconnector 160 may simultaneously transmit the lower-right submatrix B3 of the second operand matrix, loaded from the storage device 140, to the processing device 100-2 and the processing device 100-4. The processing device 100-2 and the processing device 100-4 may store the received submatrix B3 in their respective internal memories 200.

After the transmission of all operand submatrices required for the second-stage computation is finished through the steps S1050 to S1080, at step S1090 each processing device 100-1, 100-2, 100-3, or 100-4 may compute a second partial product using the submatrices stored in its internal memory 200 and accumulate the second partial product to the partial product result stored in the step S1040 step.

For example, the processing device 100-1 may multiply the upper-right submatrix A1 of the first operand matrix with the lower-left submatrix B2 of the second operand matrix and may then accumulate the multiplication result into the partial product P0 generated in the step S1040 to derive the upper-left submatrix C0 of the resultant matrix. The processing device 100-2 may multiply the upper-right submatrix A1 of the first operand matrix with the lower-right submatrix B3 of the second operand matrix and may then accumulate the multiplication result into the partial product P1 generated in the step S1040 to derive the upper-right submatrix C1 of the resultant matrix. The processing device 100-3 may multiply the lower-right submatrix A3 of the first operand matrix with the lower-left submatrix B2 of the second operand matrix and may then accumulate the multiplication result into the partial product P2 generated in the step S1040 to derive the lower-left submatrix C2 of the resultant matrix. The processing device 100-4 may multiply the lower-right submatrix A3 of the first operand matrix with the lower-right submatrix B3 of the second operand matrix and may then accumulate the multiplication result into the partial product P3 generated in the step S1040 to derive the lower-right submatrix C3 of the resultant matrix.

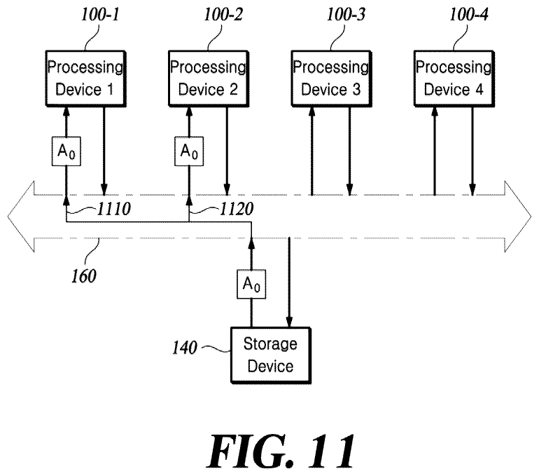

FIG. 11 is a diagram illustrating data transmission paths activated in a distributed matrix multiplication operation process according to an embodiment of the present disclosure.

The operand submatrices loaded from the storage device 140 may be transmitted to the processing devices via the interconnector 160. To this end, the storage device 140 may be defined as a source, and a plurality of data transmission paths, in which each of a combination of processing devices corresponding to the operand submatrix is defined as a target, may be simultaneously activated.

FIG. 11 illustrates the paths through which the submatrix A0 is transferred in the first step S1000 shown in FIG. 10. Referring to FIG. 11, in the step S1000, the path 1110 for transmitting data from the storage device 140 to the processing device 100-1 and the path 1120 for transmitting data from the storage device 140 to the processing device 100-2 may be simultaneously activated. Such data transmission paths may be implemented through the multicast function provided in the interconnector 160. For example, when one-to-many communication is performed based on the address structure shown in FIG. 3, the interconnector 160 may receive an address or a packet in which the flag bits of the device identification field 300 mapped to two or more processing devices are set to “1.” For example, in the step S1000, the interconnector 160 may receive an address or a packet in which the value of the device identification field 300 is set to “0011.” Such an address or packet may be provided by the controller 120, but the present disclosure is not limited to the specific example.

Since each operand submatrix only needs to be read once from the storage device 140, bandwidth may be reduced. Also, since the operand submatrix may be delivered to a plurality of processing devices at once, the transmission speed may be improved.

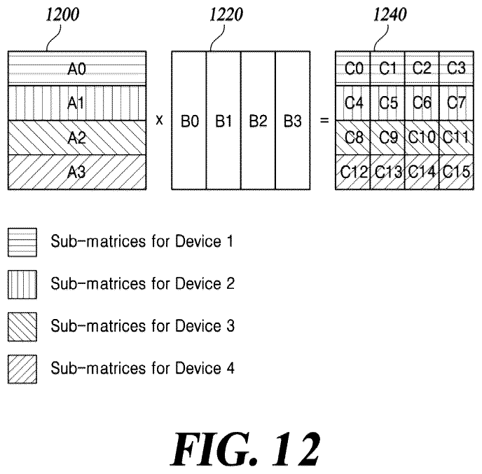

FIG. 12 is an exemplary diagram referenced to describe a distributed matrix multiplication operation according to another embodiment of the present disclosure.

The operand matrices 1200 and 1220 may be divided in the column direction and in the row direction, respectively. For example, the first operand matrix 1200 may be divided into P×1 submatrices, and the second operand matrix 1220 may be divided into 1×Q submatrices. FIG. 12 shows an example in which the first operand matrix 1200 is divided into 4×1 submatrices A0 to A3, and the second operand matrix 1220 is divided into 1×4 submatrices B0 to B3. Each processing device 100-1, 100-2, 100-3, or 100-4 may be dedicated to computing one or more submatrices among the P×Q submatrices of the resultant matrix 1240.

In some examples, each of the submatrices A0 to A3 of the first operand matrix 1200 may be preloaded into the processing device 100-1, 100-2, 100-3, or 100-4. For example, when the first operand matrix 1200 corresponds to weights (or parameters) of an artificial neural network, the submatrices A0 to A3 may be pre-stored in a distributed manner across the processing devices 100-1, 100-2, 100-3, and 100-4. Each processing device 100-1, 100-2, 100-3, or 100-4 may be dedicated to calculating the submatrices correspond to the positions of the pre-stored submatrices A0, A1, A2, and A3 among a plurality of submatrices C0 to C15 constituting the resultant matrix 1440. For example, the processing device 100-1 may be allocated to compute the submatrices C0 to C3 forming the first row, the processing device 100-2 may compute the submatrices C4 to C7 forming the second row, the processing device 100-3 may compute the submatrices C8 to C11 forming the third row, and the processing device 100-4 may compute the submatrices C12 to C15 forming the fourth row.

The submatrices B0, B1, B2, and B3 of the second operand matrix 1220 may be supplied to all processing devices 100-1, 100-2, 100-3, and 100-4 participating in the computation. To improve the efficiency of memory bandwidth during the supply of the corresponding submatrices B0, B1, B2, and B3, the multicast function of the interconnector 160 may be utilized. For example, the interconnector 160 may simultaneously transmit each operand submatrix B0, B1, B2, or B3 loaded from the storage device 140 to the processing devices 100-1, 100-2, 100-3, and 100-4.

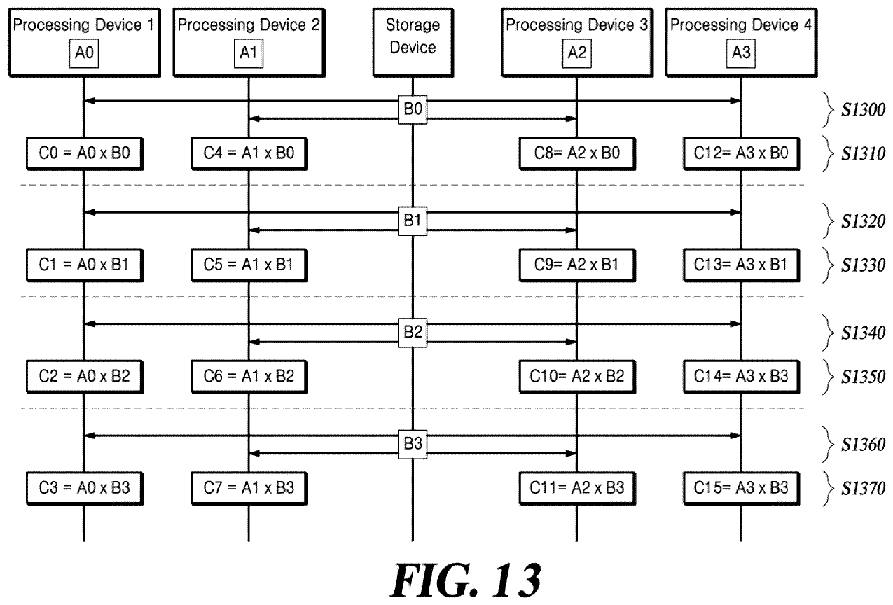

FIG. 13 is a diagram illustrating a distributed matrix multiplication operation process according to another embodiment of the present disclosure.

The distributed matrix multiplication shown in FIG. 12 may consist of a plurality of stages in which the submatrices B0, B1, B2, and B3 of the second operand matrix 1220 are sequentially supplied to compute the corresponding submatrices C0 to C15.

For example, at step S1300, the interconnector 160 may multicast the submatrix B0, which constitutes the first row of the second operand matrix 1220, to the processing devices 100-1, 100-2, 100-3, and 100-4. At step S1310, each processing device 100-1, 100-2, 100-3, or 100-4 may multiply the submatrix A0, A1, A2, or A3 stored in its internal memory 200 with the received submatrix B0 and may derive the submatrix C0, C4, C8, or C12 constituting the resultant matrix 1240.

At step S1320, the interconnector 160 may multicast the submatrix B1, which constitutes the second row of the second operand matrix 1220, to the processing devices 100-1, 100-2, 100-3, and 100-4. At step 1330, Each processing device 100-1, 100-2, 100-3, or 100-4 may multiply the submatrix A0, A1, A2, or A3 stored in its internal memory 200 with the received submatrix B1 and may derive the submatrix C1, C5, C9, or C13 constituting the resultant matrix S1330.

At step S1340, the interconnector 160 may multicast the submatrix B2, which constitutes the third row of the second operand matrix 1220, to the processing devices 100-1, 100-2, 100-3, and 100-4. At step S1350, each processing device 100-1, 100-2, 100-3, or 100-4 may multiply the submatrix A0, A1, A2, or A3 stored in its internal memory 200 with the received submatrix B2 and may derive the submatrix C2, C6, C10, or C14 constituting the resultant matrix.

At step 1360, the interconnector 160 may multicast the submatrix B3, which constitutes the fourth row of the second operand matrix 1220, to the processing devices 100-1, 100-2, 100-3, and 100-4. At step 1370, each processing device 100-1, 100-2, 100-3, or 100-4 may multiply the submatrix A0, A1, A2, or A3 stored in its internal memory 200 with the received submatrix B3 and may derive the submatrix C3, C7, C11, or C15 constituting the resultant matrix.

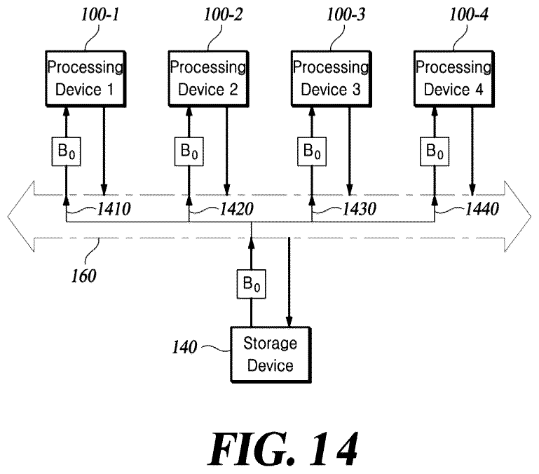

FIG. 14 is a diagram illustrating data transmission paths activated in a distributed matrix multiplication operation process according to another embodiment of the present disclosure.

The operand submatrices loaded from the storage device 140 may be transmitted to all processing devices 100-1, 100-2, 100-3, and 100-4 participating in the computation via the interconnector 160. To this end, the storage device 140 may be defined as a source, and a plurality of data transmission paths, in which each of the processing devices 100-1, 100-2, 100-3, and 100-4 is defined as a target, may be simultaneously activated.

FIG. 14 illustrates the paths along which the submatrix B0 is transferred in the first step S1000 illustrated in FIG. 13. Referring to FIG. 14, the path 1410 for transmitting data from the storage device 140 to the processing device 100-1, the path 1420 for transmitting data from the storage device 140 to the processing device 100-2, the path 1430 for transmitting data from the storage device 140 to the processing device 100-3, and the path 1440 for transmitting data from the storage device 140 to the processing device 100-4 may be activated simultaneously. The data transmission paths may be implemented through the multicast function provided in the interconnector 160. For example, when one-to-many communication is performed based on the address structure shown in FIG. 3, the interconnector 160 may receive an address or a packet in which all flag bits of the device identification field 300 are set to “1,” i.e., the device identification field 300 is set to the value “1111.” Such an address or packet may be provided by the controller 120, but the present disclosure is not limited to the specific example.

Since each submatrix of the second operand matrix only needs to be read once from the storage device 140, bandwidth may be reduced. Also, since the operand submatrix may be delivered to a plurality of processing devices at once, the transmission speed may be improved.

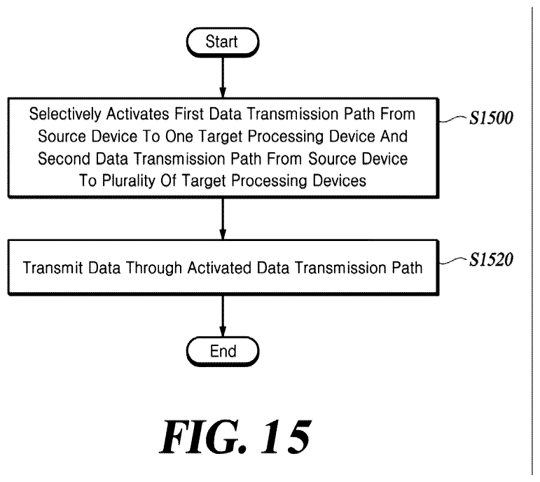

FIG. 15 is a flowchart illustrating a data transmission method for distributed operations according to an embodiment of the present disclosure.

At step 1500, the interconnector 160 may selectively activate a first data transmission path from a source device to one target processing device and a second data transmission path from the source device to a plurality of target processing devices. Here, the source device may include one of the plurality of processing devices 100-1, 100-2, 100-3, and 100-4 or a storage device 140 shared by the plurality of processing devices 100-1, 100-2, 100-3, and 100-4. The interconnector 160 may receive a first packet including flag bits indicating whether data is to be transmitted to each of the plurality of processing devices 100-1, 100-2, 100-3, and 100-4, and an address at which the data is to be stored. The interconnector 160 may activate a path indicated by the flag bits among the paths formed between the plurality of processing devices. For example, the interconnector 160 may activate the first data transmission path by activating only one of a plurality of paths that constitute the second data transmission path.

At step S1520, the interconnector 160 may transmit data through the activated data transmission path. For example, the interconnector 160 may simultaneously transmit a second packet that includes data delivered from the source device and an address included in the first packet to one or more target processing devices indicated by the flag bits.

In some examples, the processes illustrated in FIG. 15 may be applied, after the plurality of processing devices 100-1, 100-2, 100-3, and 100-4 have performed operations on operand data in a distributed manner, to share the operation results. For example, the plurality of processing devices may be configured to perform collective operations including scatter, gather, broadcast, all-reduce, and/or all-gather operation. Each processing device may divide the data to be synchronized with other processing devices into a plurality of chunk data (e.g., chunk data C₁₀ to C₁₃, C₂₀ to C₂₃, C₃₀ to C₃₃, and C₄₀ to C₄₄ in FIG. 4 or FIG. 5). The data may be divided into the same number of chunk data as the number of processing devices 100-1, 100-2, 100-3, and 100-4. Each processing device 100-1, 100-2, 100-3, or 100-4 may identify, at each of a plurality of time steps (e.g., T1-1, T1-2, and T1-3 in FIG. 5), target chunk data corresponding to the current time step from among the divided chunk data. At each of the time steps, the plurality of processing devices 100-1, 100-2, 100-3, and 100-4 may identify chunk data at different positions among the respective divided chunk data as their respective target chunk data. Each processing device may be configured to transmit the identified target chunk data or data computed from the identified target chunk data to a first neighboring processing device through the first data transmission path of the interconnector 160. The interconnector 160 may simultaneously activate a plurality of first data transmission paths in which each of the plurality of processing devices 100-1, 100-2, 100-3, and 100-4 is defined as a source device. Here, the computed data may be a result obtained by performing a reduce operation (e.g., S₀₁ to S₃₁ and S₀₂ to S₃₂ in FIG. 5) on the data received from a second neighboring processing device at the previous time step and the target chunk data identified at the current time step. The reduce operation may include, for example, addition, multiplication, maximum selection, minimum selection, logical OR, or logical AND. The first neighboring processing device and the second neighboring processing device may be different processing devices predetermined by a user or a designer based on each processing device 100-1, 100-2, 100-3, or 100-4. For example, in the example of FIG. 5, processing device 100-2 and processing device 100-4 may be predefined as the first neighboring processing device and the second neighboring processing device of processing device 100-1, respectively. Each of the plurality of processing devices 100-1, 100-2, 100-3, and 100-4 may be defined as the first neighboring processing device and the second neighboring processing device for only one processing device. At the last time step among a plurality of time steps, each processing device may generate, based on data received from the second neighboring processing device (e.g., S₀₂, S₁₂, S₂₂, or S₃₂ of FIG. 5) and residual chunk data which has not been transmitted to the first neighboring processing device (e.g., C₄₀, C₁₁, C₂₂, or C₃₃ of FIG. 5), a collective operation result (e.g., S₀, S₁, S₂, or S₃ of FIG. 5) for the corresponding residual chunk data. After the plurality of time steps, the plurality of processing devices 100-1, 100-2, 100-3, and 100-4 may sequentially transmit collective operation results for chunk data at different positions among the divided chunk data. Each processing device may simultaneously transmit the generated collective operation result to other processing devices through the second data transmission path of the interconnector 160. The interconnector 160 may, after the plurality of time steps, sequentially activate the second data transmission paths in which each of the plurality of processing devices 100-1, 100-2, 100-3, and 100-4 is defined as the source device, and all remaining processing devices are defined as the target processing devices.

In some examples, the processes illustrated in FIG. 15 may be applied before matrix multiplication is performed in a distributed manner on a first operand matrix and a second operand matrix, to deliver at least a portion of the first operand matrix and the second operand matrix to the plurality of processing devices. For example, the interconnector 160 may sequentially activate, across a plurality of time steps, the second data transmission paths in which the storage device 140 is defined as the source device and different combinations of the plurality of processing devices 100-1, 100-2, 100-3, and 100-4 are defined as the target processing devices. At each time step, the interconnector 160 may simultaneously transmit a submatrix of the first operand matrix or a submatrix of the second operand matrix to the corresponding combination of target processing devices. In another example, the plurality of processing devices 100-1, 100-2, 100-3, and 100-4 may store different submatrices of the first operand matrix. Across a plurality of time steps, different submatrices of the second operand matrix loaded from the storage device 140 may be sequentially transmitted through the second data transmission path of the interconnector 160. In other words, at each time step, the interconnector 160 may simultaneously transmit a single particular submatrix of the second operand matrix to the processing devices 100-1, 100-2, 100-3, and 100-4 that respectively store different submatrices of the first operand matrix.

The components described in the example embodiments may be implemented by hardware components including, for example, at least one digital signal processor (DSP), a processor, a controller, an application-specific integrated circuit (ASIC), a programmable logic element, such as an FPGA, other electronic devices, or combinations thereof. At least some of the functions or the processes described in the example embodiments may be implemented by software, and the software may be recorded on a recording medium. The components, the functions, and the processes described in the example embodiments may be implemented by a combination of hardware and software.

The method according to example embodiments may be embodied as a program that is executable by a computer, and may be implemented as various recording media such as a magnetic storage medium, an optical reading medium, and a digital storage medium.

Various techniques described herein may be implemented as digital electronic circuitry, or as computer hardware, firmware, software, or combinations thereof. The techniques may be implemented as a computer program product, i.e., a computer program tangibly embodied in an information carrier, e.g., in a machine-readable storage device (for example, a computer-readable medium) or in a propagated signal for processing by, or to control an operation of a data processing apparatus, e.g., a programmable processor, a computer, or multiple computers. A computer program(s) may be written in any form of a programming language, including compiled or interpreted languages and may be deployed in any form including a stand-alone program or a module, a component, a subroutine, or other units suitable for use in a computing environment. A computer program may be deployed to be executed on one computer or on multiple computers at one site or distributed across multiple sites and interconnected by a communication network.

Processors suitable for execution of a computer program include, by way of example, both general and special purpose microprocessors, and any one or more processors of any kind of digital computer. Generally, a processor will receive instructions and data from a read-only memory or a random access memory or both. Elements of a computer may include at least one processor to execute instructions and one or more memory devices to store instructions and data. Generally, a computer will also include or be coupled to receive data from, transfer data to, or perform both on one or more mass storage devices to store data, e.g., magnetic, magneto-optical disks, or optical disks. Examples of information carriers suitable for embodying computer program instructions and data include semiconductor memory devices, for example, magnetic media such as a hard disk, a floppy disk, and a magnetic tape, optical media such as a compact disk read only memory (CD-ROM), a digital video disk (DVD), etc. and magneto-optical media such as a floptical disk, and a read only memory (ROM), a random access memory (RAM), a flash memory, an erasable programmable ROM (EPROM), and an electrically erasable programmable ROM (EEPROM) and any other known computer readable medium. A processor and a memory may be supplemented by, or integrated into, a special purpose logic circuit.

The processor may run an operating system (OS) and one or more software applications that run on the OS. The processor device also may access, store, manipulate, process, and create data in response to execution of the software. For purpose of simplicity, the description of a processor device is used as singular; however, one skilled in the art will be appreciated that a processor device may include multiple processing elements and/or multiple types of processing elements. For example, a processor device may include multiple processors or a processor and a controller. In addition, different processing configurations are possible, such as parallel processors.

Also, non-transitory computer-readable media may be any available media that may be accessed by a computer, and may include both computer storage media and transmission media.

The present specification includes details of a number of specific implements, but it should be understood that the details do not limit any invention or what is claimable in the specification but rather describe features of the specific example embodiment. Features described in the specification in the context of individual example embodiments may be implemented as a combination in a single example embodiment. In contrast, various features described in the specification in the context of a single example embodiment may be implemented in multiple example embodiments individually or in an appropriate sub-combination. Furthermore, the features may operate in a specific combination and may be initially described as claimed in the combination, but one or more features may be excluded from the claimed combination in some cases, and the claimed combination may be changed into a sub-combination or a modification of a sub-combination.

Similarly, even though operations are described in a specific order on the drawings, it should not be understood as the operations needing to be performed in the specific order or in sequence to obtain desired results or as all the operations needing to be performed. In a specific case, multitasking and parallel processing may be advantageous. In addition, it should not be understood as requiring a separation of various apparatus components in the above described example embodiments in all example embodiments, and it should be understood that the above-described program components and apparatuses may be incorporated into a single software product or may be packaged in multiple software products.

According to an embodiment of the present disclosure, low latency and high throughput may be achieved by improving the efficiency of data transmission for collective operations and/or distributed matrix-multiplication operations while using minimal hardware resources. Accordingly, distributed learning of large-scale artificial neural networks may be performed more efficiently.

The technical effects of the present disclosure are not limited to the technical effects described above, and other technical effects not mentioned herein may be understood to those skilled in the art to which the present disclosure belongs from the description above.

It should be understood that the example embodiments disclosed herein are merely illustrative and are not intended to limit the scope of the invention. It will be apparent to one of ordinary skill in the art that various modifications of the example embodiments may be made without departing from the spirit and scope of the claims and their equivalents.

Accordingly, one of ordinary skill would understand that the scope of the claimed invention is not to be limited by the above explicitly described embodiments but by the claims and equivalents thereof.

What is claimed is:

1. A computing device comprising:
a plurality of processing devices; and
an interconnector connected to the plurality of processing devices and configured to provide data transmission paths for the plurality of processing devices,
wherein the interconnector is configured to selectively activate a first data transmission path from a source device, to one target processing device and a second data transmission path from the source device to a plurality of target processing devices, and
wherein the source device includes one of the plurality of processing devices or a storage device shared by the plurality of processing devices.

2. The computing device of claim 1, wherein the interconnector is configured to receive a first packet including flag bits indicating whether data is to be transmitted to each of the plurality of processing devices and an address at which the data is to be stored.

3. The computing device of claim 2, wherein the interconnector is configured to simultaneously transmit a second packet that includes data delivered from the source device and the address to one or more target processing devices indicated by the flag bits.

4. The computing device of claim 1, wherein the plurality of processing devices are configured to perform operations on operand data in a distributed manner.

5. The computing device of claim 1, wherein each of the plurality of processing devices is configured to:
divide data to be synchronized with other processing devices into a plurality of chunk data;
identify, at each of a plurality of time steps, target chunk data corresponding to a current time step from among the divided chunk data; and
transmit the identified target chunk data or data computed from the identified target chunk data to a first neighboring processing device through the first data transmission path of the interconnector.

6. The computing device of claim 5, wherein the computed data is a result obtained by performing a reduce operation on the data received from a second neighboring processing device at a previous time step and the target chunk data identified at the current time step,
wherein the reduce operation includes addition, multiplication, maximum selection, minimum selection, logical OR, or logical AND.

7. The computing device of claim 5, wherein a plurality of first data transmission paths in which each of the plurality of processing devices is defined as the source device are activated simultaneously, and,
wherein the plurality of processing devices are configured to identify, as respective target chunk data, chunk data at different positions among respective divided chunk data at each of the time steps.

8. The computing device of claim 6, wherein, at the last time step among the plurality of time steps, each of the plurality of processing devices is configured to generate, based on data received from the second neighboring processing device and residual chunk data which has not been transmitted to the first neighboring processing device, a collective operation result for corresponding residual chunk data.

9. The computing device of claim 8, wherein each of the plurality of processing devices is configured to simultaneously transmit the generated collective operation result to the other processing devices through the second data transmission path of the interconnector.

10. The computing device of claim 5, wherein the interconnector is configured to, after the plurality of time steps, sequentially activate the second data transmission paths in which each of the plurality of processing devices is defined as the source device, and all remaining processing devices are defined as the target processing devices.

11. The computing device of claim 5, wherein, after the plurality of time steps, the plurality of processing devices sequentially transmit collective operation results for chunk data at different positions among the divided chunk data.

12. The computing device of claim 5, wherein the plurality of processing devices are configured to perform a collective operation including scatter, gather, broadcast, all-reduce, or all-gather, and
wherein a total number of the plurality of chunk data is equal to a total number of the plurality of processing devices.

13. The computing device of claim 1, wherein the plurality of processing devices are configured to perform matrix multiplication on a first operand matrix and a second operand matrix in a distributed manner.

14. The computing device of claim 13, wherein second data transmission paths, in which the storage device is defined as the source device, and different combinations of the plurality of processing devices are defined as the target processing devices, are sequentially activated across a plurality of time steps.

15. The computing device of claim 14, wherein the interconnector is configured to simultaneously transmit a submatrix of the first operand matrix or a submatrix of the second operand matrix to a corresponding combination of target processing devices.

16. The computing device of claim 13, wherein the second data transmission path, in which the storage device is defined as a source device, and the plurality of processing devices are defined as the target processing devices, is activated across a plurality of time steps.

17. The computing device of claim 16, wherein the plurality of processing devices are configured to store different submatrices of the first operand matrix, and
wherein the interconnect is configured to sequentially receive different submatrices of the second operand matrix from the storage device at a plurality of time steps and transmit the received different submatrices via the second data transmission path.

18. The computing device of claim 1, wherein the activating of the first data transmission path activates only one of a plurality of paths constituting the second data transmission path.

19. A method performed by an interconnector connected to a plurality of processing devices and configured to provide data transmission paths for the plurality of processing devices, the method comprising:
selectively activating a first data transmission path from a source device to one target processing device and a second data transmission path from the source device to a plurality of target processing devices; and
transmitting data through the activated data transmission path,
wherein the source device includes one of the plurality of processing devices or a storage device shared by the plurality of processing devices.

20. An interconnector connected to a plurality of processing devices and configured to provide data transmission paths for the plurality of processing devices, the interconnector being configured to selectively activate a first data transmission path from a source device to one target processing device and a second data transmission path from the source device to a plurality of target processing devices,
wherein the source device includes one of the plurality of processing devices or a storage device shared by the plurality of processing devices.
